(19) United States
(12) Patent Application Publication
(10) Pub. No.: US 2025/0121433 A1
(43) Pub. Date: Apr. 17, 2025

(54) OSCILLATING-PRESSURE-AND-SPARK-PLASMA COMBINED SINTERING EQUIPMENT AND SINTERING METHOD

(71) Applicants: Precision Industry Revolution Equipment Technology (Henan) Co., Ltd., Zhengzhou (CN); ZHENGZHOU RESEARCH INSTITUTE FOR ABRASIVES & GRINDING CO., LTD., Zhengzhou (CN)

(72) Inventors: Jiong ZHAO, Beijing (CN); Ning YAN, Zhengzhou (CN); Jun WEI, Zhengzhou (CN); Yanjun ZHAO, Zhengzhou (CN); Jianfeng CAO, Zhengzhou (CN); Xiangxu MENG, Zhengzhou (CN); Ruifeng HAN, Zhengzhou (CN); Yang ZHANG, Zhengzhou (CN); Xiaolei WU, Zhengzhou (CN); Ying XIA, Zhengzhou (CN)

(73) Assignees: Precision Industry Revolution Equipment Technology (Henan) Co., Ltd., Zhengzhou, HA (CN); ZHENGZHOU RESEARCH INSTITUTE FOR ABRASIVES & GRINDING CO., LTD., Zhengzhou, HA (CN)

(21) Appl. No.: 18/397,934

(22) Filed: Dec. 27, 2023

(30) Foreign Application Priority Data
Oct. 16, 2023 (CN) 2023113374045

(51) Int. Cl. B22F 3/105; B22F 3/10; B22F 3/16; B22F 3/24

(52) U.S. Cl. CPC B22F 3/105; B22F 3/1007; B22F 3/16; B22F 3/24; B22F 2003/1051; B22F 2003/248; B22F 2201/10; B22F 2201/20; B22F 2202/13; B22F 2203/00; B22F 2203/11; B22F 2998/10; B22F 2999/00

(57) ABSTRACT

The present disclosure discloses an oscillating-pressure-and-spark-plasma combined sintering equipment and sintering method. By providing a system comprising a mainframe structural system, a servo motor hydraulic system, an oscillating pressurized hydraulic system, a vacuum and inert gas supply system, a pulse plasma power control system, and a mainframe control system, the mainframe structure adopts a pre-tightened frame beam to ensure the strength of the system under oscillation pressure and the stability of the overall structure. The equipment is additionally provided with an oscillation hydraulic system with adjustable frequency and pressure. During the sintering process of workpieces, the oscillation pressure can achieve the slip rearrangement of particles. It adopts an overlay mode of dual hydraulic systems. Therefore, the accuracy of pressure control in the system is ensured.

### CROSS-REFERENCE TO RELATED APPLICATIONS

The present application claims priority to Chinese patent application No. 2023113374045, entitled “Oscillating-Pressure-and-Spark-Plasma Combined Sintering Equipment and Sintering Method”, filed to the China Patent Office on Oct. 16, 2023, the entire content of which is incorporated herein by reference.

### TECHNICAL FIELD

The present disclosure belongs to the technology field of vacuum sintering equipment and particularly relates to an oscillating-pressure-and-spark-plasma combined sintering equipment (that is, a sintering equipment combining oscillating pressure sintering and spark plasma sintering) and sintering method.

### BACKGROUND ART

Sintering is a crucial process in powder metallurgy, where powders are compacted under specific temperatures, pressure, and environmental conditions to achieve densification. Common sintering methods include pressure-less sintering, hot pressing sintering, hot isostatic pressing sintering, microwave sintering, and spark plasma sintering.

Spark plasma sintering utilizes the pulse discharge to excite instantaneous high temperature, surface activation, and pulse discharge pressure and other effects generated by the plasma to achieve rapid sintering for the powder, thereby making it become an advanced pressure sintering technology. Spark plasma sintering offers advantages such as rapid heating rate, short sintering time, and low sintering temperatures, thereby making it have important application potential for the production of high-performance materials.

Traditional spark plasma sintering equipment, however, applies a static and constant pressure, which has certain limitations in the material sintering process. These limitations mainly manifest as the inability to deal with particle agglomeration of the green body in the early stages of sintering and the inefficiency in removing pores between grain boundaries in the later stages of sintering, thus restricting the improvement of material density and mechanical properties.

In recent years, the application of oscillating pressure in powder preparation and material processing has become increasingly widespread. Relevant research indicates that oscillating pressure can accelerate atomic migration and the movement and removal of pores between grain boundaries in the later stages of sintering. The oscillating pressure provides a higher sintering driving force, thereby promoting densification of the green body while suppressing the growth of the grain. This offers a new method for preparing advanced materials with high density, high strength, and fine grains. However, traditional oscillating pressure sintering equipment uses external-resistance heating, thereby leading to a longer sintering time and a tendency for grain growth.

High-performance metals and ceramic materials require further densification and grain refinement. Currently, traditional spark plasma sintering equipment and oscillating pressure sintering equipment cannot meet the manufacturing needs of high-performance materials. Currently, there is no oscillating composite multi-energy-field sintering equipment based on spark plasma sintering, either domestically or internationally. By combining spark plasma sintering with oscillating sintering, it will be possible to fully combine the advantages of rapid sintering and grain growth suppression of spark plasma sintering, and the promotion of densification of oscillating sintering. This approach is expected to offer significant advantages in the preparation of high-performance materials.

The core of the oscillating-pressure-and-spark-plasma combined sintering equipment is in the combination and precise control of constant pressure and oscillating pressure. However, the challenges in achieving precise pressure control with the oscillating pressurized hydraulic system are as follows.
1. Most hydraulic valves have a frequency response that does not exceed 4 Hz, thereby making it almost impossible to achieve an oscillating frequency of 10 Hz or higher in the system.
2. Static constant pressure is controlled by a servo motor, and it requires a custom-made compound pump, along with PID calculations during pressure adjustment through PLC. Achieving pressure control with a stability of 0.15% FS for the system is quite challenging.
3. Due to the high oscillating frequency of the system, using a high-power motor to achieve such an oscillating frequency contradicts the concept of green manufacturing.
4. With the high oscillating frequency of the oscillating pressurized hydraulic system, the acquisition and computation performed by the PLC control system become inadequate. High-speed data acquisition cards, single-board computers, or industrial PCs are needed for separate control.

### SUMMARY

To address the shortcomings of existing technology, the objective of the present disclosure is to provide an oscillating-pressure-and-spark-plasma combined sintering equipment that ensures the strength and overall structural stability of the system under oscillating pressure. It employs an overlay mode of dual hydraulic systems to guarantee precise pressure control. Additionally, the oscillating-pressure-and-spark-plasma combined sintering equipment is configured for the preparation of high-performance metals and ceramic materials with ultra-high hardness and high toughness. It can effectively enhance the performance of sintered products.

In order to solve the above technical problems, the technical solutions adopted in the present disclosure are as follows.

An oscillating-pressure-and-spark-plasma combined sintering equipment comprises a mainframe structural system, a servo motor hydraulic system, an oscillating pressurized hydraulic system, a vacuum and inert gas supply system, a pulse plasma power control system, and a mainframe control system.

The mainframe structural system comprises a main frame, a vacuum chamber, upper and lower electrode heads, and an upper infrared temperature measurement device. The upper infrared temperature measurement device is arranged at the top of the main frame, and its infrared light passes through a quartz window to reach the sintered workpiece placed inside the vacuum chamber.

The main frame comprises an upper beam and a lower beam, along with corresponding pillars arranged between them. The upper and lower beams are fastened by corresponding pre-tightening screws arranged at two ends of the pillars; the upper electrode head is correspondingly fixed to the upper beam, while the lower electrode head is fixed on a sliding beam which is movably provided. The sliding beam is slidingly connected to a lower-positioned oil cylinder which is correspondingly arranged, and drives the lower electrode head to pressurize the sintered workpiece. The lower-positioned oil cylinder, along with the servo motor hydraulic system and the oscillating pressurized hydraulic system, performs a dual-system overlay control.

The pulse plasma power control system is connected to the upper and lower electrode heads and enables programmable control sintering for the sintered workpiece. The vacuum and inert gas supply system is connected to the vacuum chamber and, under the action of the mainframe control system, is subjected to a closed-loop control.

The servo motor hydraulic system comprises a servo motor, a gear pump connected to it, and a second plunger pump which is coaxially and rotationally connected to the gear pump; the gear pump is connected to a first solenoid valve through a pipeline, wherein the first solenoid valve is connected to the lower-positioned oil cylinder through a pipeline, thereby providing it with static idle-run pressure.

The oscillating pressurized hydraulic system comprises a three-phase asynchronous motor, a first plunger pump, and an electro-hydraulic servo valve. The three-phase asynchronous motor is connected to the first plunger pump. The first plunger pump communicates with the electro-hydraulic servo valve through a pipeline and provides unidirectional high-frequency alternating pressure to the lower-positioned oil cylinder.

A second solenoid valve is further arranged in the pipeline between the first solenoid valve and the electro-hydraulic servo valve. The second solenoid valve is connected to the second plunger pump and provides static high-pressure pressing.

A one-way valve is arranged on the pipeline between the gear pump and the first solenoid valve, a throttle valve is arranged on the pipeline between the one-way valve and the first solenoid valve, and an overflow valve is arranged on the pipeline between the gear pump and the throttle valve.

A pipeline located upstream of the second plunger pump and the second solenoid valve is further provided in parallel with an overflow valve, and a first hydraulic gauge is provided on the pipeline between the overflow valve and the second plunger pump.

A one-way valve is further provided on the pipeline between the first plunger pump and the electro-hydraulic servo valve, and a proportional relief valve and a second hydraulic gauge are further provided on the pipeline between the one-way valve and the electro-hydraulic servo valve.

An accumulator, a pressure strain gauge, and a third hydraulic gauge are further provided in sequence on the pipeline between the electro-hydraulic servo valve and the lower-positioned oil cylinder.

A first oil filter is further provided on the pipeline between the one-way valve and the proportional relief valve, and a second oil filter is provided on the pipeline between the electro-hydraulic servo valve and the lower-positioned oil cylinder.

The external part of the vacuum chamber is provided with a water-cooling system, and the water-cooling system is connected to the mainframe control system.

A displacement measurement device is provided on the lower beam, and the displacement measurement device is connected to the mainframe control system.

A sintering method using an oscillating-pressure-and-spark-plasma combined sintering equipment comprises the following steps:
1) ensuring that the power source, water source, and gas source are operating normally, and placing the graphite mold containing the sintered material inside the vacuum chamber;
2) controlling the atmosphere and pressure inside the vacuum chamber using the vacuum and inert gas supply system; and applying appropriate pressure on the sintered material using the servo motor hydraulic system and the oscillating pressurized hydraulic system;
3) heating the sintered material by using the pulse plasma power control system according to the set sintering process, wherein at this point, static pressure and oscillating pressure act simultaneously on the sintered material; the dual effects of spark plasma sintering and oscillating sintering promote the activation and particle rearrangement of the sintered material, thereby effectively enhancing the properties of the material;
4) slowly cooling, after the sintering is complete, the sintered material and the graphite mold under the influence of the water-cooling system, while adjusting the sintering pressure as needed;
5) removing the sintered material and the graphite mold from the vacuum chamber once the sintered material and the graphite mold have cooled to room temperature, and unloading the mold to remove the material.

The present disclosure has the following advantageous effects.
(1) The present disclosure discloses an oscillating-pressure-and-spark-plasma combined sintering equipment and sintering method. By providing a system comprising a mainframe structural system, a servo motor hydraulic system, an oscillating pressurized hydraulic system, a vacuum and inert gas supply system, a pulse plasma power control system, and a mainframe control system, the mainframe structure adopts a frame beam to be pre-tightened to ensure the strength of the system under oscillating pressure and the stability of the overall structure. The equipment is additionally provided with an oscillating hydraulic system with adjustable frequency and pressure. The combination of spark plasma sintering and oscillating sintering can fully combine the advantages of rapid sintering and grain growth suppression of spark plasma sintering, and the promotion for densification in oscillating sintering. During the sintering process of workpieces, the oscillating pressure can achieve the slipping and rearrangement of particles, thereby helping with the elimination of pores, and enabling high-density sintering of materials. It adopts an overlay mode of dual hydraulic systems, which is energy-efficient and environmentally friendly, prevents excessively rapid increase of oil temperature and offers easy and simple switching. Therefore, the accuracy of pressure control in the system is ensured. The present disclosure provides an oscillating-pressure-and-spark-plasma combined sintering equipment and sintering method capable of preparing high-performance materials, which can be widely used for the sintering preparation of high-performance and high-value-added materials.
(2) The mainframe structure is provided with an upper infrared temperature measurement device with a window cleaning function. The upper temperature measurement device no longer requires frequent position adjustment based on the size of the workpiece. Additionally, the measurement point for the upper temperature measurement device is closer to the material, providing a direct reflection of the temperature of the sintered material. This allows for more precise control of sintering temperature, achieving accurate, convenient, stable and reliable high-temperature measurements.
(3) The lower-positioned oil cylinder is supplied with oil from two hydraulic systems, enabling rapid and precise static pressure control. Therefore, the stability and reliability of the system are ensured, and the stability and consistency of the pressed products are guaranteed. Convenient and swift adjustment of oscillating frequency and amplitude, along with precise control, can achieve high-density and high-strength pressing for product. The use of an accumulator, for the absorption and release of pressure oil, accelerates the pressure rising rate while reducing the displacement of the oil pump and the configuration of the motor power.
(4) A precision displacement sensor is provided on the side to achieve a displacement measurement accuracy of 0.001 mm, which can collect data on the contraction of sintered powder particles, thus obtaining a densification curve of the powder sintering process. The sintering process curve can be adjusted and controlled in real-time based on specific conditions.

### BRIEF DESCRIPTION OF DRAWINGS

FIG. 1 is the main view of the present disclosure;

FIG. 2 is the top view of the present disclosure;

FIG. 3 is a schematic diagram of the structure of the mainframe structural system;

FIG. 4 is a sectional view along direction D-D of FIG. 3;

FIG. 5 is a schematic diagram of the structure of the hydraulic system;

FIG. 6 is a SEM image of tungsten steel in Example 1;

FIG. 7 is a SEM image of tungsten steel in Example 2;

FIG. 8 is a SEM image of tungsten steel in Example 3;

Table 1 is the pressure action table for the hydraulic system; and Table 2 is a performance comparison table for sintering case examples.

### DETAILED DESCRIPTION OF EMBODIMENTS

The following specific embodiments are provided to illustrate the implementation of the present disclosure. Those skilled in the art can easily understand other advantages and effects of the present disclosure based on the content disclosed in the summary.

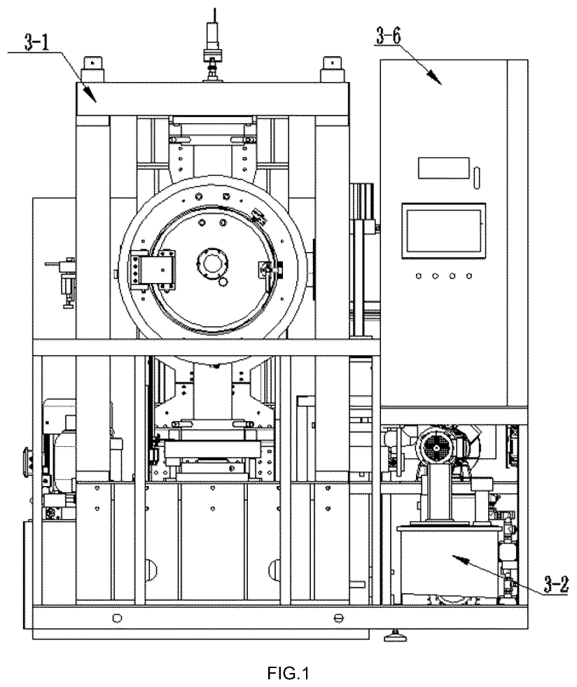

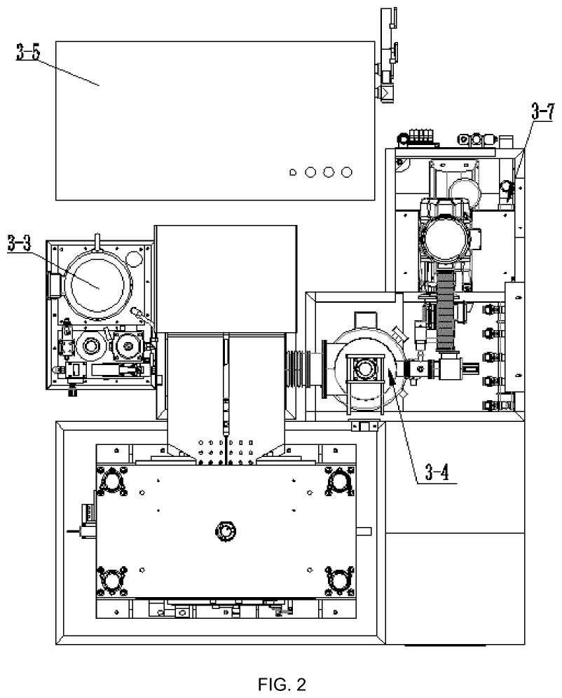

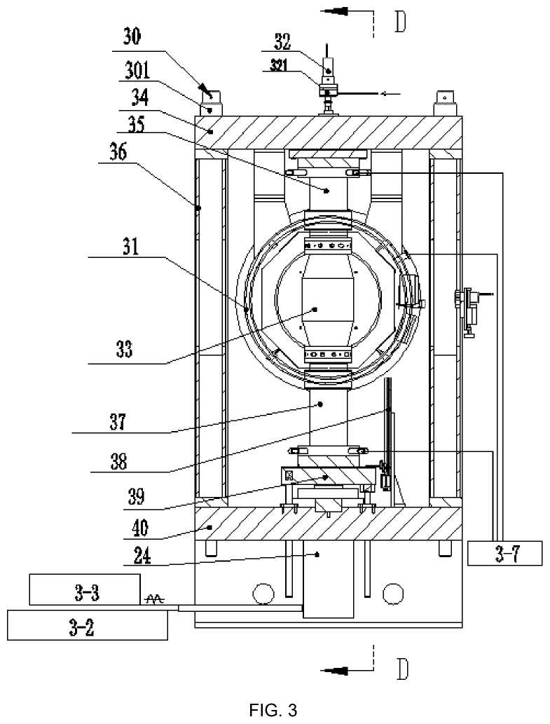

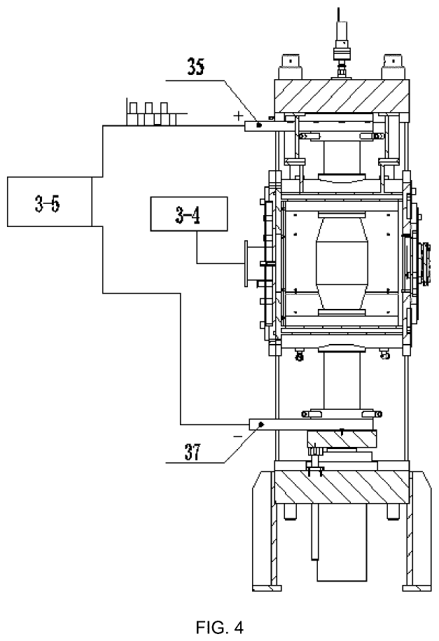

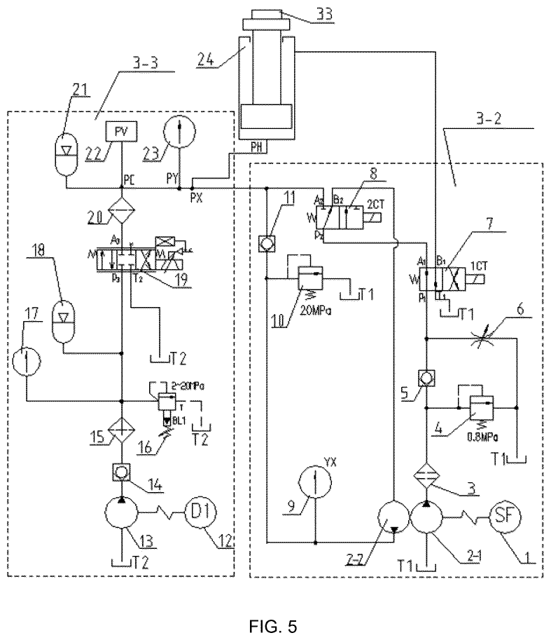

The present disclosure provides an oscillating-pressure-and-spark-plasma combined sintering equipment as shown in FIGS. 1 to 8.

The oscillating-pressure-and-spark-plasma combined sintering equipment comprises a mainframe structural system 3-1, a servo motor hydraulic system 3-2, an oscillating pressurized hydraulic system 3-3, a vacuum and inert gas supply system 3-4, a pulse plasma power control system 3-5, and a mainframe control system 3-6. The mainframe structural system 3-1 comprises a main frame, a vacuum chamber 31, upper and lower electrode heads, and an upper infrared temperature measurement device 32. The upper infrared temperature measurement device 32 is arranged at the top of the main frame, and its infrared light passes through a quartz window to reach the sintered workpiece 33 placed inside the vacuum chamber 31.

A thermocouple device for temperature measuring (0-1000° C.) is provided inside the vacuum chamber, and the upper infrared temperature measurement device (300-2500° C.) is also provided, thus enabling measurement at both high and low temperatures. Infrared light of the upper infrared temperature measurement device 32 passes through the quartz glass window 321, as well as the reserved holes in the upper beam 34 and the upper pressure head electrode 35, to reach the sintered workpiece 33. This accurately measures the central temperature of the workpiece to be sintered.

The main frame comprises an upper beam 34 and a lower beam 40, along with corresponding pillars 36 arranged between them. The upper and lower beams are fastened by corresponding pre-tightening screws arranged at the two ends of the pillars. The upper electrode head is correspondingly fixed to the upper beam, while the lower electrode head 37 is fixed on a sliding beam 39 which is movably provided. The sliding beam 39 is slidingly connected to a lower-positioned oil cylinder 24 which is correspondingly arranged, and drives the lower electrode head 37 to pressurize the sintered workpiece 33. The lower-positioned oil cylinder 24, along with the servo motor hydraulic system and the oscillating pressurized hydraulic system, performs a dual-system overlay control.

In the embodiment, the upper and lower beams, along with the pillars, constitute the main frame structure of the equipment. Four threaded rods 30 are applied to secure the upper and lower beams. Subsequently, the threaded rods 30 are tensioned using a tensioner, which is set to a tension of 200 KN, and after the threaded rods 30 are tensioned, the nuts 301 are fastened. This imparts a pre-tension force of 800 KN to the upper and lower beams as well as the pillars, ensuring the strength of the entire equipment. This pre-tension force prevents the loosening of the nuts under the oscillating pressure of the oscillating pressurized hydraulic system at 10 Hz, thereby guaranteeing the stability of the mainframe structure. The vacuum chamber 31 is provided with a front-opening door and a dual-layer water-cooling structure, thereby making it user-friendly and providing the sintering space for products. The required sintering conditions are achieved by the vacuum or inert gas system. The upper and lower pressure head electrodes are connected to the pulse plasma power control system, thus enabling programmable pulse plasma discharge sintering of the workpiece. The sintered workpiece is composed of high-strength graphite molds, carbon paper, carbon felt, and the sintered powder, thus allowing for the sintering and pressing for the powder.

The pulse plasma power control system 3-5 is connected to the upper and lower electrode heads and enables programmable control sintering for the sintered workpiece. The vacuum and inert gas supply system is connected to the vacuum chamber and, under the action of the mainframe control system, is subjected to a closed-loop control.

The servo motor hydraulic system comprises a servo motor 1, a gear pump 2-1 connected to it, and a second plunger pump 2-2 which is coaxially and rotationally connected to the gear pump 2-1. The gear pump 2-1 is connected to a first solenoid valve 7 through a pipeline, wherein the first solenoid valve 7 is connected to the lower-positioned oil cylinder 24 through a pipeline, thereby providing it with static pressure. The oscillating pressurized hydraulic system comprises a three-phase asynchronous motor 12, a first plunger pump 13, and an electro-hydraulic servo valve 19. The three-phase asynchronous motor 12 is connected to the first plunger pump 13. The first plunger pump 13 communicates with the electro-hydraulic servo valve 19 through a pipeline and provides unidirectional high-frequency alternating pressure to the lower-positioned oil cylinder 24.

A second solenoid valve 8 is further arranged in the pipeline between the first solenoid valve 7 and the electro-hydraulic servo valve 19. The second solenoid valve 8 is connected to the second plunger pump 2-2.

A first one-way valve 5 is arranged on the pipeline between the gear pump 2-1 and the first solenoid valve 7, a throttle valve 6 is arranged on the pipeline between the first one-way valve 5 and the first solenoid valve 7, and an overflow valve 4 is arranged on the pipeline between the gear pump 2-1 and the throttle valve. A pipeline located upstream of the second plunger pump 2-2 and the second solenoid valve 8 is further provided in parallel with an overflow valve 10, and a first hydraulic gauge 9 is provided on the pipeline between the overflow valve 10 and the second plunger pump 2-2.

A third one-way valve 14 is further provided on the pipeline between the first plunger pump 13 and the electro-hydraulic servo valve 19, and a proportional relief valve 16 and a second hydraulic gauge 17 are further provided on the pipeline between the third one-way valve 14 and the electro-hydraulic servo valve 19. A second accumulator 21, a pressure strain gauge 22, and a third hydraulic gauge 23 are further provided in sequence on the pipeline between the electro-hydraulic servo valve 19 and the lower-positioned oil cylinder 24.

A first oil filter 15 is further provided on the pipeline between the third one-way valve 14 and the proportional relief valve 16, and a second oil filter 20 is provided on the pipeline between the electro-hydraulic servo valve 19 and the lower-positioned oil cylinder 24.

The external part of the vacuum chamber is provided with a water-cooling system 3-7, and the water-cooling system 3-7 is connected to the mainframe control system. In the embodiment, the vacuum chamber is provided with a front-opening door and a dual-layer water-cooling structure, thereby making it user-friendly and providing the sintering space for products. The required sintering conditions are achieved by the vacuum or inert gas system.

A displacement measurement device 38 is provided on the lower beam, and the displacement measurement device 38 is connected to the mainframe control system. In the embodiment, displacement measurement device 38 uses a precision displacement sensor, and the lower-positioned oil cylinder 24 is supplied with oil from two hydraulic systems. A precision displacement sensor is provided on the side to achieve a displacement measurement accuracy of 0.001 mm, which can collect data on the contraction of sintered powder particles, thus obtaining a densification curve of the powder sintering process. The sintering process curve can be adjusted and controlled in real-time based on specific conditions.

In the embodiment, the interior of the vacuum chamber is also provided with an internal thermocouple device for temperature measuring (0-1000° C.), in conjunction with the upper infrared temperature measurement device, to enable measurement at both high and low temperatures. The infrared light from an infrared thermometer of the upper infrared temperature measurement device passes through the quartz glass window, as well as the reserved holes in the upper beam and the upper pressure head electrodes, to reach the sintered workpiece. This accurately measures the central temperature of the workpiece to be sintered. This structure requires consideration of the sealing of the temperature measurement system and the vacuum chamber, as well as insulation for the upper electrode head and the contamination of the quartz glass window by volatiles. After a certain period of use of equipment, the quartz glass window will become contaminated, with some volatiles adhering to its surface, or the infrared light path will become blocked by graphite paper, carbon felt, or other debris. All of these issues can impact the transparency of the infrared light, resulting in significant temperature measurement deviations. Therefore, using inert gas to blow away contaminants from the surface of the quartz glass and the infrared light path ensures the accuracy of the temperature measurement system and the stability of the system.

Furthermore, compared to traditional side temperature measurement, the upper infrared temperature measurement device 32 eliminates the need for frequent position adjustment based on the size of the workpiece. The measurement point for upper-temperature measurement is closer to the material, allowing it to directly reflect the temperature of the material to be sintered, and thus enabling more precise control of the sintering temperature.

In the embodiment, the mainframe control system 3-6 is mainly composed of a PLC and driver, among other components, and it achieves closed-loop control of the temperature, pressure, displacement, cooling water pressure and flow, pulse power supply, vacuum unit, and inert gas of the equipment.

The servo motor hydraulic system 3-2 is connected to the gear pump 2-1 of the compound oil pump by the servo motor 1 and provides static pressure. It drives the sliding beam 39 to move up and down, ensuring a pressure accuracy of 0.15% FS. The other set of oscillating pressurized hydraulic system 3-3 is connected to the first plunger pump 13 by a three-phase asynchronous motor 12. It provides unidirectional high-frequency alternating pressure through the electro-hydraulic servo valve 19. The frequency of 0-10 Hz and pressure amplitude can be set according to the process requirements. Oscillating pressure sintering can optimize the microstructure of the material, reduce pores inside the material, and enhance the density and mechanical performance of the material, resulting in advanced engineering materials with high density, strength, and reliability.

The pulse plasma power control system 3-5 provides pulsed current with different duty cycles to the electrodes, ranging from 0 to 80000A, with voltage from 0 to 10V through a transformer, which are transmitted to the sintered powder through the upper and lower electrodes. Heating is achieved through the spark plasma generated by the powder itself. The plasma and the activated effect produced by energization lead to rapid temperature rising and sintering of the powder. When the sintering temperature is below 1000° C., temperature measurement is performed using the thermocouple device arranged inside the chamber. If the sintering temperature is within the range of 1000-2400° C., the temperature measurement is performed using the infrared device arranged at the top of the mainframe. The temperature measured by either the thermocouple device or the infrared device is transmitted to a temperature controller. The temperature controller, based on the process parameters, sends signals to the mainframe control system to adjust the heating power, thereby enabling PID control of the temperature.

The water-cooling system 3-7 is composed of valves, flow sensors, and temperature sensors. It provides the water circulation cooling to the vacuum chamber, upper and lower electrodes, pulsed power control system, and vacuum pump unit. The flow rate and return water temperature can be in a closed-loop control to ensure the proper functioning of each system.

When the equipment is operating, the process begins by opening the door of the vacuum chamber. The graphite mold, containing the powder to be sintered, is placed between the upper and lower electrode heads. The precise servo motor hydraulic system is started, and the hydraulic system is controlled slowly using a hand wheel to raise the sliding beam, ensuring that the mold and upper and lower electrode heads make tight contact. The door of the vacuum chamber is closed. On the panel of the mainframe control system, high or low vacuum are selected, and the sintering process route is configured. When the vacuum system reaches the required conditions, it is selected whether to protect the sintering process with an inert atmosphere. If atmosphere protection is required, the mainframe control system will automatically open the solenoid valve to introduce inert gas. Following the set process curve, the hot-pressing sintering process begins. During the sintering process, if oscillating pressure is needed, the system will activate the oscillating pressurized hydraulic system as required by the process. Once the sintering is complete and the resultant is cooled to an appropriate temperature, the vacuum system or the inert gas protection system is closed, and the vacuum is released. The hydraulic system retracts, and the sintered workpiece can be removed.

In the embodiment, the oscillating pressurized hydraulic system that enables precise pressure control is formed by two hydraulic systems. One set is the servo motor hydraulic system that achieves precise static pressurization with pressure accuracy controlled within 0.15% FS. The other set is the hydraulic system for oscillating pressure, which is superimposed with it. The specific structure is shown in the hydraulic schematic diagram 1.

1. The static pressing process comprises the following steps: idle run-pressing-pressure release and return.

### Idle Run:

The servo motor 1 is set to the required speed and starts, driving the gear pump 2-1 to operate. Hydraulic oil flows through the third oil filter 3, the first one-way valve 5, the first solenoid valve 7, and enters port P2 of the second solenoid valve 8. At this point, 2CT of the second solenoid valve 8 is energized, thereby causing it to close. The hydraulic oil flows from port P2 to port A2, then to the working oil cylinder 24 at port PH, pushing the piston inside the lower-positioned oil cylinder 24 upward. When the piston pressure head makes contact with the workpiece, the pressing begins. As the oil pressure rises, exceeding 0.8 MPa, the overflow valve 4 is unloaded, and the throttle valve 6 regulates the time when unloading. At this point, the system needs to enter the pressing state.

Pressing: Because pressing requires higher pressure, 2CT is de-energized, causing the second solenoid valve 8 to be in the left position. Port P2 communicates with B2. The hydraulic oil flows from P2 to B2, and passes through the second plunger pump 2-2 of the compound oil pump, the first hydraulic gauge 9, and the second one-way valve 11 to enter the rod less cavity of the oil cylinder, providing pressure to the workpiece. The compound oil pump achieves secondary pressure boosting, the first hydraulic gauge 9 displays the pressure after boosting, and the third hydraulic gauge 23 displays the pressure in the rod less cavity. The pressure strain gauge 22 measures the pressure in rod less cavity and compares it with the set process pressure. When it reaches or exceeds the set value of the process pressure range, the servo motor 1 is turned off. When the pressure exceeds the set pressure value, the first solenoid valve 1CT is energized; and when unloaded incrementally to the set pressure range, the first solenoid valve 1CT is de-energized. After a period of time, the pressure of the system gradually drops below the set pressure value. The pressure strain gauge 22 provides feedback to the PLC, which starts the servo motor 1 to repressurize the system. This process is repeated to achieve precise pressure control.

Return: At this stage, both 1CT and 2CT are energized. The servo motor 1 starts and hydraulic oil flows through the first solenoid valve B1 into the rod chamber of the lower-positioned oil cylinder 24, pushing the piston rod downward. The hydraulic oil in the rod less chamber flows through port A2 of the second solenoid valve 8 to port P2, then through port A1 of the first solenoid valve 7 to T1, and returns back to oil tank 1.

### 2. Oscillating Pressure

Depending on the size of the sintered workpiece, the oscillating frequency (0-10 Hz) and oscillating pressure amplitude are set. At this time, both 1CT and 2CT are de-energized, and the servo motor 1 is turned off. The servo hydraulic system ceases its operation. The three-phase asynchronous motor 12 starts, and hydraulic oil passes through the first plunger pump 13, the third one-way valve 14, the first oil filter 15, the proportional relief valve 16, the second hydraulic gauge 17, and the first accumulator 18, and reaches the electro-hydraulic servo valve 19. When the electro-hydraulic servo valve 19 is turned on, it is output by the command from its front end and passes through the servo amplifier, so that the hydraulic system outputs oscillating pressure with a controllable frequency and amplitude strictly based on the command. Additionally, real-time pressure is measured by the pressure strain gauge 22, and the processor conducts high-speed data acquisition. After extensive data processing, filtering, signal amplification, and other tasks, it sends commands to the electro-hydraulic servo valve 19, thus enabling the electro-hydraulic servo valve 19 to output the frequency and the amplitude which are set by the system. The electro-hydraulic servo valve 19 is driven to the left position, allowing hydraulic oil to enter from port P3 to port A3. It flows through the second oil filter 20 and the second accumulator 21, and enters the rod less cavity of the lower-positioned oil cylinder 24, thus achieving the maximum system pressure PH. When the electro-hydraulic servo valve 19 is driven to the right position, port A3 of the electro-hydraulic servo valve communicates with port T2. The hydraulic oil in the rod less cavity of the oil cylinder flows through the pressure strain gauge 22 and the second oil filter 20, and then returns back to oil tank T2, thereby achieving the minimum system pressure PL. This process achieves the transition between high-pressure PH and low-pressure PL. At this point, hydraulic oil cannot enter the electro-hydraulic servo valve 19 through port P3. The hydraulic oil output by the first plunger pump 13 can only be relieved through the proportional relief valve 16 into oil tank T2 or be absorbed by the first accumulator 18.

The system continuously repeats the above process to achieve the oscillating pressure with the set frequency and amplitude.

The following Table 1, pressure precision control and oscillating pressure action table, shows the action of the hydraulic system in the automatic mode, and in conjunction with this table, it illustrates the working principle of the system for pressure precision control and oscillating pressure process in the automatic mode.

TABLE 1
Pressure Precision Control and Oscillating Pressure Action Table

| | | | Solenoid Valve | | | | | |
|---|---|---|---|---|---|---|---|---|
| | | Transmitting | | | | SF | Motor | |
| | Action | Element | 1CT | 2CT | BL1 | valve | SF | D1 |
| | Static Pressurization - | Setting rotation | | + | | | + | |
| | idle run | speed of PLC | | | | | | |
| | Static Pressurization | Setting rotation | | | | | + | |
| | pressing | speed of PLC | | | | | | |
| [symbol] Industrial Controller Control Cycle | Oscillation Pressure to PH Oscillation Pressure to PL PH PL Pressure Adjustment | set signal of industrial controller Set signal of industrial controller Set signal of industrial controller | | | + + + | + + | | + + + |
| | Return | PLC program | | + | + | | + | |
| | | control | | | | | | |
| | Stop | Stroke switch | | | | | | |

### Example 1

In the example, a method for preparing ultrafine non-bonded phase tungsten steel material using oscillating-pressure-and-spark-plasma combined sintering equipment was provided. The method comprised the following steps.
\textcircled{1} Dosing: The raw materials were weighed according to the formula design, with WC powder 98.9 wt %, and carbide powder 1.1 wt %.
\textcircled{2} Blending: The prepared raw materials were placed in a PP blending tank, and grinding media and anhydrous ethanol were added. An acoustic resonance mixing equipment set at 80 g acceleration was used for 10 min. Then, the uniformly mixed slurry was vacuum-dried, and the grinding media was sieved out using a 40-mesh screen to obtain sintering powder.
\textcircled{3} Sintering:
1) The power source, water source, and gas source were checked, and the graphite mold containing WC sintering powder was placed in the vacuum chamber.
2) Initial pressure was applied to the sintered material by the servo motor hydraulic system, and the chamber pressure was reduced to below 10 Pa by the vacuum control system.
3) The sintered material and the graphite mold were heated using the pulse plasma power control system. During sintering, the material was heated at a rate of 100° C./min to 1000° C., and the pressure was increased from the initial pressure to 50 MPa. Subsequently, the temperature was raised at a rate of 100° C./min to 1600° C. while maintaining the pressure unchanged. Finally, the sintering temperature was maintained at 1600° C. for 10 min. Additionally, during sintering, the water-cooling system controlled the inflow and outflow of cooling water to maintain the temperature of the upper and lower electrode heads within the normal range.
4) After the sintering process was complete, the sintered material and graphite mold gradually cooled down under the influence of the water-cooling system.
5) Once the temperature of the sintered material and graphite mold had cooled to room temperature, the sintering was complete, and the sintered material was removed from the vacuum chamber.

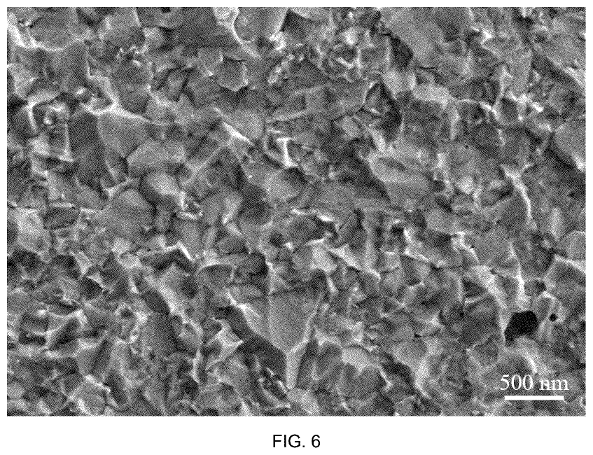

The ultrafine non-bonded phase tungsten steel material prepared in the example is shown in FIG. 6.

### Example 2

In the example, a method for preparing ultrafine non-bonded phase tungsten steel material using oscillating-pressure-and-spark-plasma combined sintering equipment was provided. Following the operating steps of Example 1, as distinguished from Example 1, the sintering temperature was set at 1800° C.

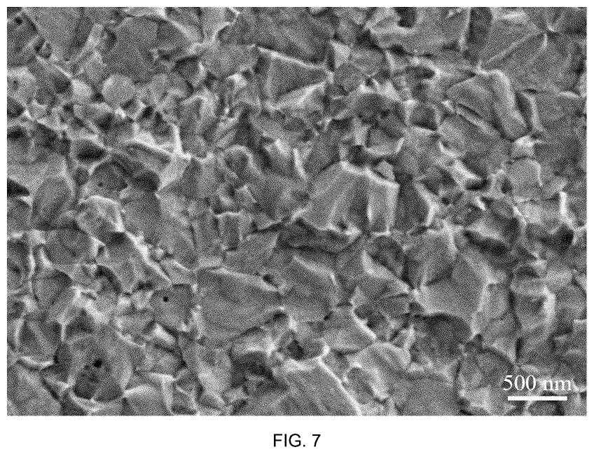

The ultrafine non-bonded phase tungsten steel material prepared in the example is shown in FIG. 7.

### Example 3

In the example, a method for preparing ultrafine non-bonded phase tungsten steel material using oscillating-pressure-and-spark-plasma combined sintering equipment was provided. Following the operating steps of Example 1, as distinguished from Example 1, the sintering temperature was set at 1600° C. At the same time, when the sintering temperature reached 1000° C., oscillating pressure with an amplitude of 5 MPa and a frequency of 5 Hz was added. After the thermal insulation process was completed, the oscillating pressure was canceled.

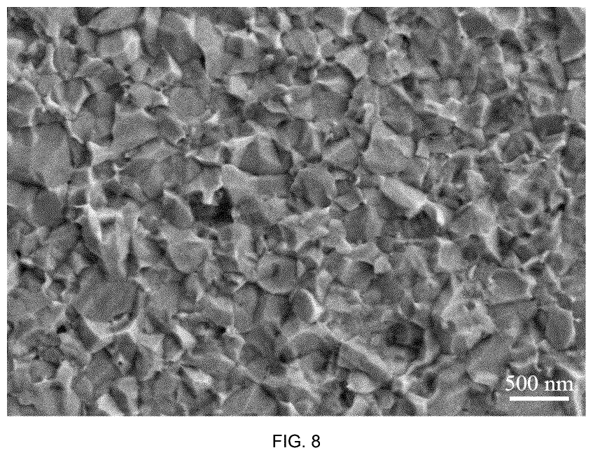

The ultrafine non-bonded phase tungsten steel material prepared in the example is shown in FIG. 8.

The properties of the ultrafine non-bonded phase tungsten steel material obtained in Examples 1-3 were tested, and the specific results are shown in Table 2. It can be observed that when the sintering temperature is increased from 1600° C. to 1800° C., the density of the material increases by 1.6%, but the grain size increases to 560 nm. The material prepared using the oscillating-pressure-and-spark-plasma combined sintering method achieves a sintered density at 1600° C. similar to that at 1800° C., while the average grain size remains the same as that at 1600° C., demonstrating good overall mechanical performance.

TABLE 2
Performance Comparison Table of Sintering Case Examples

| | | Vickers | Average Grain |
|---|---|---|---|
| | Density (g/cm³) | Microhardness (HV) | Size (nm) |
| Example 1 | 15.21 | 2421 | 450 |
| Example 2 | 15.45 | 2613 | 560 |
| Example 3 | 15.50 | 2688 | 410 |

The above has demonstrated and described the basic principles, main features, and advantages of the present disclosure. Those skilled in the art should understand that the present disclosure is not limited to the above embodiments. The embodiments and descriptions provided in the summary are only illustrative of the principles of the present disclosure. Within the spirit and scope of the present disclosure, various changes and improvements can be made. These changes and improvements are also encompassed within the scope of the present disclosure for which protection is claimed. The scope of protection for the present disclosure is defined by the appended claims and their equivalents.

In the description of the present disclosure, it should be noted that the terms such as “front”, “rear”, “left”, “right”, “center”, and so on, which indicate directions or positional relationships, are based on the orientations or positions shown in the drawings. These terms are used for the purpose of describing the present disclosure and simplifying the description, and they do not imply or suggest that the device or components being referred to must have specific orientations or be constructed and operated in a particular way. Therefore, these terms should not be construed as limitations on the scope of protection for the present disclosure.

What is claimed is:

1. An oscillating-pressure-and-spark-plasma combined sintering equipment, comprising a mainframe structural system, a servo motor hydraulic system, an oscillating pressurized hydraulic system, a vacuum and inert gas supply system, a pulse plasma power control system, and a mainframe control system,
wherein the mainframe structural system comprises a main frame, a vacuum chamber, upper and lower electrode heads, and an upper infrared temperature measurement device; and the upper infrared temperature measurement device is arranged at a top of the main frame, and its infrared light passes through a quartz window to reach a sintered workpiece placed inside a vacuum chamber;
the main frame comprises an upper beam and a lower beam, along with corresponding pillars arranged between them; the upper beam and the lower beam are fastened by corresponding pre-tightening screws arranged at two ends of the pillars; the upper electrode head is correspondingly fixed to the upper beam, and the lower electrode head is fixed on a sliding beam which is movably provided; the sliding beam is slidingly connected to a lower-positioned oil cylinder which is correspondingly arranged, and drives the lower electrode head to pressurize the sintered workpiece; and the lower-positioned oil cylinder, along with the servo motor hydraulic system and the oscillating pressurized hydraulic system, performs a dual-system overlay control; and
the pulse plasma power control system is connected to the upper and lower electrode heads and enables programmable control sintering of the sintered workpiece; and the vacuum and inert gas supply system is connected to the vacuum chamber and, under an action of the mainframe control system, is subjected to a closed-loop control.

2. The oscillating-pressure-and-spark-plasma combined sintering equipment according to claim 1, wherein the servo motor hydraulic system comprises a servo motor, a gear pump connected thereto, and a second plunger pump which is coaxially and rotationally connected to the gear pump; and the gear pump is connected to a first solenoid valve through a pipeline, wherein the first solenoid valve is connected to the lower-positioned oil cylinder through a pipeline, thereby providing a static idle-run pressure;
the oscillating pressurized hydraulic system comprises a three-phase asynchronous motor, a first plunger pump, and an electro-hydraulic servo valve; and the three-phase asynchronous motor is connected to the first plunger pump, and the first plunger pump communicates with the electro-hydraulic servo valve through a pipeline and provides unidirectional high-frequency alternating pressure for the lower-positioned oil cylinder; and
a second solenoid valve is further arranged in a pipeline between the first solenoid valve and the electro-hydraulic servo valve; and the second solenoid valve is connected to the second plunger pump and provides static high-pressure pressing.

3. The oscillating-pressure-and-spark-plasma combined sintering equipment according to claim 2, wherein a one-way valve is arranged on a pipeline between the gear pump and the first solenoid valve, a throttle valve is arranged on a pipeline between the one-way valve and the first solenoid valve, and an overflow valve is arranged on a pipeline between the gear pump and the throttle valve.

4. The oscillating-pressure-and-spark-plasma combined sintering equipment according to claim 3, wherein a pipeline located upstream of the second plunger pump and the second solenoid valve is further provided in parallel with an overflow valve, and a first hydraulic gauge is provided on a pipeline between the overflow valve and the second plunger pump.

5. The oscillating-pressure-and-spark-plasma combined sintering equipment according to claim 3, wherein a one-way valve is further provided on a pipeline between the first plunger pump and the electro-hydraulic servo valve, and a proportional relief valve and a second hydraulic gauge are further provided on a pipeline between the one-way valve and the electro-hydraulic servo valve.

6. The oscillating-pressure-and-spark-plasma combined sintering equipment according to claim 2, wherein an accumulator, a pressure strain gauge, and a third hydraulic gauge are further provided in sequence on a pipeline between the electro-hydraulic servo valve and the lower-positioned oil cylinder.

7. The oscillating-pressure-and-spark-plasma combined sintering equipment according to claim 5, wherein a first oil filter is further provided on a pipeline between the one-way valve and the proportional relief valve, and a second oil filter is provided on a pipeline between the electro-hydraulic servo valve and the lower-positioned oil cylinder.

8. The oscillating-pressure-and-spark-plasma combined sintering equipment according to claim 1, wherein an external part of the vacuum chamber is provided with a water-cooling system, and the water-cooling system is connected to the mainframe control system.

9. The oscillating-pressure-and-spark-plasma combined sintering equipment according to claim 8, wherein a displacement measurement device is provided on the lower beam, and the displacement measurement device is connected to the mainframe control system.

10. A sintering method for the oscillating-pressure-and-spark-plasma combined sintering equipment according to claim 1, wherein the method comprises following steps:
1) checking a power source, a water source, and a gas source, and placing a graphite mold containing a sintered material inside the vacuum chamber;
2) controlling an atmosphere and a pressure inside the vacuum chamber using the vacuum and inert gas supply system; applying a required static pressure and oscillating pressure on the sintered material using the servo motor hydraulic system and the oscillating pressurized hydraulic system, wherein the oscillating pressure facilitates an expulsion of pores and facilitates an improvement of a sintering density of a material;
3) by using the pulse plasma power control system, heating a material to be sintered according to a set sintering process; controlling an entry and a discharge of a cooling water through a water-cooling system during sintering to ensure that temperatures of the upper and lower electrode heads remain within a normal range;
4) slowly cooling, after a sintering process is complete, the sintered material and the graphite mold under a influence of the water-cooling system, and adjusting a sintering pressure as needed; and
5) removing the sintered material from the vacuum chamber once the sintered material and the graphite mold have cooled to a room temperature, the sintering is completed.
